(19) United States
(12) Patent Application Publication
(10) Pub. No.: US 2021/0172567 A1
(43) Pub. Date: Jun. 10, 2021

(54) THREE-DIMENSIONAL SHELL STRUCTURE, PRESSURE VESSEL HAVING SAME, AND MANUFACTURING METHOD THEREFOR

(71) Applicant: INDUSTRY FOUNDATION OF CHONNAM NATIONAL UNIVERSITY, Gwangju (KR)

(72) Inventors: Ki Ju KANG, Jeollanam-do (KR); Cheng Han WU, Gwangju (KR); Yoon Chang JEONG, Gwangju (KR)

(73) Assignee: Industry Foundation of Chonnam National University, Gwangju (KR)

(21) Appl. No.: 17/045,926

(22) PCT Filed: Jan. 23, 2019
(86) PCT No.: PCT/KR2019/000953

§ 371 Date: Oct. 7, 2020

(30) Foreign Application Priority Data
Apr. 9, 2018 (KR) 10-2018-0041156

(51) Int. Cl. F17C 1/00; B21F 27/12; F16J 12/00

(52) U.S. Cl. CPC F17C 1/00; B21F 27/12; F17C 2209/232; F17C 2201/0166; F16J 12/00

(57) ABSTRACT

Disclosed is a pressure vessel for storing and keeping fluid and a three-dimensional shell structure used therefor. The pressure vessel has a shell structure in which an inner part is divided and partitioned into two sub volumes which are twisted with each other, by the interface and sub volumes are continuous, as a main body of the pressure vessel, and two sub volumes are independently utilized as a storage space of a high pressure vessel or a space for receiving or moving a heat exchange medium.

### CROSS-REFERENCE TO PRIOR APPLICATIONS

This application is a National Stage Patent Application of PCT International Patent Application No. PCT/KR2019/000953 (filed on Jan. 23, 2019) under 35 U.S.C. § 371, which claims priority to Korean Patent Application No. 10-2018-0041156 (filed on Apr. 9, 2018), which are all hereby incorporated by reference in their entirety.

### BACKGROUND

The present invention relates to a pressure vessel for storing and keeping a fluid and a three-dimensional shell structure used therefor.

Generally, pressure vessels are used to store and keep a high-pressure fluid therein. For example, an industrial gas cylinder which stores fluids such as liquid oxygen and nitrogen is a pressure vessel which receives a pressure of 120 atmospheres and a nuclear reactor of a nuclear power station is a pressure vessel which keeps a water of 315° C. and 160 atmospheres and finally produces steam which operates a turbine for electric power generation. In the related art, the pressure vessel is generally fabricated to have a cylinder type or a sphere type to endure a high pressure with a low weight. FIG. 1 illustrates a relationship of a cylinder type or a sphere type shell of a normal pressure vessel of the related art and a maximum principal stress generated on a shell wall when an internal pressure P is applied in the pressure vessel.

However, the pressure vessel 1′ with a cylinder type or a sphere type shell of the related has the following problems: In order to keep a large amount of high pressure fluid, a vessel formed with a thick shell as much as the amount of pressure fluid needs to be used. Therefore, it tends to cause a fatal explosion when a crack occurs. Further, an external appearance is limited to a cylinder type or a sphere type shell so that it is difficult to fix the vessel to a specific position and the vessel occupies a large space. Further, except for the nuclear reactor which directly generates heat therein, a surface of the shell configuring the pressure vessel 1′ which is in contact with outside air is limited to an outer peripheral surface of the shell and a specific surface is small so that heat transfer characteristic to and from the shell is poor. Therefore, it is disadvantageous to heat or cool the fluid in the pressure vessel 1′ depending on the purpose of the pressure vessel 1′.

In the meantime, in 1865, a German mathematician H. A. Schwarz announced a triply periodic minimal surface (TPMS) with a mean curvature of zero as a curved structure which was periodically repeated without self-intersecting in a three-dimensional space (Gesammelte Mathematische Abhandlungen, Springer). In this case, the mean curvature refers to a mean value of a maximum curvature and a minimum curvature in two directions which are perpendicular to each other at one point on a three-dimensional plane and represents how much the three-dimensional plane is curved. In the 1960s, A. Schoen organized this and added several new TPMS (S. Hyde et al., The Language of Shape, Elsevier, 1997, ISBN 978-0-444-81538-5). There are various types TPMS and among them, as illustrated in FIG. 2, a P surface, a D surface, and a G surface are most commonly cited in the field of Chemistry and Biology. In nature, the TPMS is found from water-emulsifier mixtures, cell thin films, sea urchin epidermal placode, or silicate meso-phase and most of them is present in the form of an interface which separates two phases, but is not found in the form of a lightweight porous structure.

Moreover, the above-described TPMS with zero mean curvature divides a space into two consecutive sub volumes and a volume ratio of the sub-volumes is 1:1. Even when the volume ratio is different, a minimal surface with a constant mean curvature which divides the space into two sub volumes may be defined and this curved surface is also referred to as TPMS (cited document: M. Maldovan and E. L. Thomas, “Periodic Materials and Interference Lithography, 2009 WILEY-VCH Verlag GmbH & Co. KGaA, ISBN: 978-3-527-31999-2).

Two sub volumes which are defined by dividing the space by the interface formed by the TPMS curve are continuous and twisted with each other. When a TPMS type shell structure is fabricated, a constant mean curvature is ensured at everywhere on the interface so that it is known that when an external load is applied, since the stress is not concentrated at any one portion, early local buckling is not caused and a strength is higher with respect to the weight (S. C. Kapfer, S. T. Hyde, K. Mecke, C. H. Arns, G. E. Schroder-Turk, Minimal surface scaffold designs for tissue engineering, Biomaterials 32(2011) 6875-6882). Further, each sub volume enclosed by smooth curved surfaces has a large surface area and has high permeability when fluid flow therein. Therefore, a thin film at a border between two sub volumes is highly likely to be utilized as heat and mass transfer interfaces between two sub volumes.

Recently, two notable methods have been proposed as practical processes for fabricating a TPMS type thin film structure. Kiju Kang et al., reported that a similar type to a P surface illustrated in FIG. 2 can be fabricated by applying a method of fabricating a multi-phase thin film structure based on photo lithography proposed in Korean Registered Patent No. 1341216. Further, Kiju Kang et al., proposed a fabricating technique of a thin film structure having a P surface and a D surface based on a wire-woven structure in Korean Registered Patent No. 1699943. Further, Kiju Kang et al., proposed a fabricating technique of a thin film structure having a P surface, an F-RD surface, an IW-P surface based on a plurality of beads which is regularly arranged, in Korean Unexamined Patent Application Publication No. 10-2018-0029454.

Based on a fact that as a shell structure which is partitioned into two sub volumes by an interface, specifically, a TPMS type shell structure has a constant mean curvature so that it may endure a high internal pressure, inventors of the present invention expect that when the shell structure is applied as a pressure vessel, the problems of the pressure vessel with the cylinder type or a sphere type shell of the related art may be solved, which results in the present invention.

### SUMMARY

An object of the present invention is to provide a pressure vessel which has an excellent pressure resistance characteristic with a large storage volume with respect to a weight, an excellent specific surface area, a fluid permeability, and a heat transfer characteristic and divides the internal space to be separately utilized for every purpose, and has an excellent degree of freedom of a design of an external appearance of the vessel and a fabricating method thereof.

In order to solve the problems, the inventors pay attention to a geometric structure of a shell structure in which an inner part is separated and partitioned into two sub volumes twisted by an interface and the sub volumes are continuous to understand how to use two sub volumes as a space for storing a high pressure fluid or a space for receiving or moving a heat exchange medium and confirm that when the shell structure is specifically configured by the TPMS, a pressure vessel with a large storage volume with respect to a weight, an excellent pressure resistance characteristic, a specific surface area, a fluid permeability, and a heat transfer characteristic can be implemented so that the present invention was made. The gist of the present invention based on the recognition and the knowledge of the above solution is as follows:

(1) A three-dimensional shell structure for a pressure vessel which is separated and partitioned into two sub volumes configured by a first sub volume and a second sub volume which are twisted with each other by an interface, in which at least one of the two sub volumes is provided as a storage space for receiving fluid and a part of the sub volume provided as a storage space which is exposed to the outside, excluding a part for carrying in/out the fluid, is sealed by a shielding plate.

(2) In the three-dimensional shell structure for a pressure vessel of (1), the interface is a triply periodic minimal surface (TPMS).

(3) In the three-dimensional shell structure for a pressure vessel of (1), a sub volume other than the storage space is provided as a space for receiving or moving a heat exchange medium.

(4) In the three-dimensional shell structure for a pressure vessel of (1), the shielding plate has a planar or curved profile.

(5) In the three-dimensional shell structure for a pressure vessel of (4), the shielding plate is convex outwardly from the storage space or is concave inwardly from the storage space.

(6) A pressure vessel including a three-dimensional shell structure of any one of (1) to (5); and an inlet and an outlet which communicate with the storage space to provide a passage for carrying in/out a fluid.

(7) A fabricating method of a pressure vessel with a shell structure in which an inner part is separated and partitioned into two sub volumes configured by a first sub volume and a second sub volume twisted with each other by an interface therein and any one of the first sub volume and the second sub volume is provided as a storage space for receiving a fluid, includes (A) fabricating a template in which any one of the first sub volume and the second sub volume is filled with a template material; (B) forming a first coating film on an entire surface of the template; and (C) exposing and then removing the template material by removing a part of the first coating film, and the first coating film forms the interface and an outer peripheral surface of the shell structure.

(8) In the fabricating method of a pressure vessel (7), the step (A) further includes connecting a sealing material for forming an inlet/outlet to the exposed template material, in the step (B), a first coating film is formed on the entire exposed surface of the template material and the sealing material for forming an inlet/outlet, and in the step (C), a part of the first coating film is removed to expose the sealing material and then the sealing material and the template material are sequentially removed so that an area where the sealing material is removed is formed as an inlet and an outlet for carrying in/out a fluid.

(9) A fabricating method of a pressure vessel with a shell structure in which an inner part is separated and partitioned into two sub volumes configured by a first sub volume and a second sub volume twisted with each other by an interface therein and both the first sub volume and the second sub volume are provided as a storage space for receiving a fluid, includes: (A) fabricating a template in which any one of the first sub volume and the second sub volume is filled with a first template material; (B) forming a first coating film on an entire surface of the template; (C) filling an empty space of the other one of the first sub volume and the second sub volume with a second template material; (D) forming a second coating film after polishing an entire outer peripheral surface of the template so as to expose a cross-section of the first coating film; € exposing and then removing the first template material and a second template material by removing a part of the second coating film, and the first coating film forms the interface and the second coating film forms an outer peripheral surface of the shell structure and in the step (D), an end of the first coating film is in contact with a surface of the second coating film to be coupled.

(10) In the fabricating method of a pressure vessel (9), the step (D) includes: (D-1) polishing an entire outer peripheral surface of the template so as to expose a cross-section of the first coating film, the first template material, and the second template material; (D-2) connecting a sealing material for forming an inlet/outlet to the first template material and the second template material which are exposed; and (D-3) forming a second coating film on the sealing material and the exposed outer peripheral surface of the template, the step E is performed by sequentially removing the sealing material, the first template material, and the second template material after exposing the sealing material by removing a part of the second coating film, and an area where the sealing material is removed is formed as an inlet and an outlet for carrying in/out a fluid.

(11) A fabricating method of a pressure vessel with a shell structure in which an inner part is separated and partitioned into two sub volumes configured by a first sub volume and a second sub volume twisted with each other by an interface therein and at least one of the first sub volume and the second sub volume is provided as a storage space for receiving a fluid, in which a plane element corresponding to the interface and the outer peripheral surface of the shell structure is divided into a plurality of parts to be coupled to each other.

According to the present invention, the pressure vessel is configured by a shell structure in which an inner part is separated and partitioned into two sub volumes which are twisted with each other, by the interface and sub volumes are continuous, as a main body of the pressure vessel, and two sub volumes are independently utilized as a storage space of a high pressure vessel or a space for receiving or moving a heat exchange medium. Therefore, the pressure vessel has excellent pressure resistance characteristic with a thin wall thickness and a large storage volume with respect to a weight and also has an excellent specific surface area, fluid permeability, and heat transfer characteristic. Further, when the interface is configured by the TPMS, it is specifically advantageous in terms of a stability of the high-pressure vessel. Further, regardless of the external appearance of the vessel, the characteristic required for the pressure vessel is satisfied or improved by a geometric structure of the shell structure such as TPMS or separately utilizing the internal space so that the design restriction of the external appearance of the vessel and a location restriction for installation may be remarkably alleviated. Further, the vessel shape is freely designed so that the functionality or the external appearance characteristic related to the vessel shape may be significantly improved. For example, a portable pressure vessel such as an air tank for divers may be fabricated to be fitted in a wearing position of a human body to improve portability and wearability and a hydrogen tank or a natural gas tank for vehicles may be fabricated to have various shapes to minimize an installation space, instead of a general cylinder type.

### BRIEF DESCRIPTION OF THE DRAWINGS

FIG. 1 is a view of a structure of a pressure vessel of the related art.

FIG. 2 is a view of a structure of a triply periodic minimal surface (TPMS).

FIG. 3 is a mimetic view for recognition of separation of two sub volumes in a TPMS shell structure for a pressure vessel according to an exemplary embodiment of the present disclosure.

FIG. 4 is another mimetic view for recognition of separation of a sub volume in a P-surface shell structure of FIG. 3A.

FIG. 5 is a view of a structure analysis result for a P-surface shell structure of FIG. 3A.

FIGS. 6 to 11 are views of a structure of a pressure vessel configured by a shell structure according to exemplary embodiments of the present disclosure.

FIG. 12 is a fabricating process view of a pressure vessel according to an exemplary embodiment of the present invention.

FIG. 13 is a fabricating process view of a pressure vessel according to a modified embodiment of FIG. 12.

FIG. 14 is a fabricating process view of a pressure vessel according to another exemplary embodiment of the present invention.

FIG. 15 is a fabricating process view of a pressure vessel according to a modified embodiment of FIG. 14.

FIG. 16 is a view for comparing a pressure vessel of the related art and a pressure vessel according to the present invention which have a similar external volume.

FIG. 17 is an exemplary view of a pressure vessel with a modified external appearance by changing an arrangement method of unit cells according to an exemplary embodiment of the present disclosure.

FIG. 18 is a fabricating conceptual view of a pressure vessel according to another exemplary embodiment of the present invention.

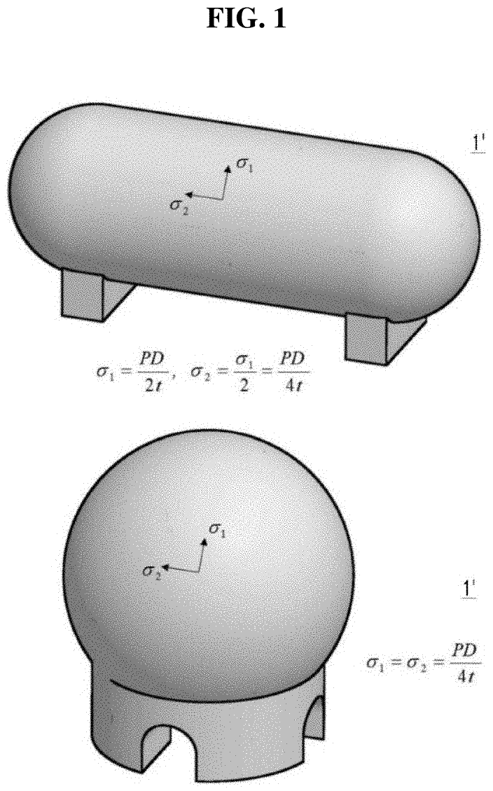

### DETAILED DESCRIPTION

Hereinafter, the present invention will be described in more detail with reference to exemplary embodiments. Prior to this, terms or words used in the present specification and claims should not be interpreted as being limited to typical or dictionary meanings, but should be interpreted as having meanings and concepts which comply with the technical spirit of the present invention, based on the principle that an inventor can appropriately define the concept of the term to describe his/her own invention in the best manner. Therefore, configurations illustrated in the embodiments described in the present specification are only the most preferred embodiment of the present invention and do not represent all of the technical spirit of the present invention, and thus it is to be understood that various equivalents and modified examples, which may replace the configurations, are possible when filing the present application. In addition, in the drawings, like components are denoted by like reference numerals. Throughout the specification, unless explicitly described to the contrary, the word “comprise” and variations such as “comprises” or “comprising”, will be understood to imply the inclusion of stated elements but not the exclusion of any other elements.

Mechanical Basis for Pressure Vessel

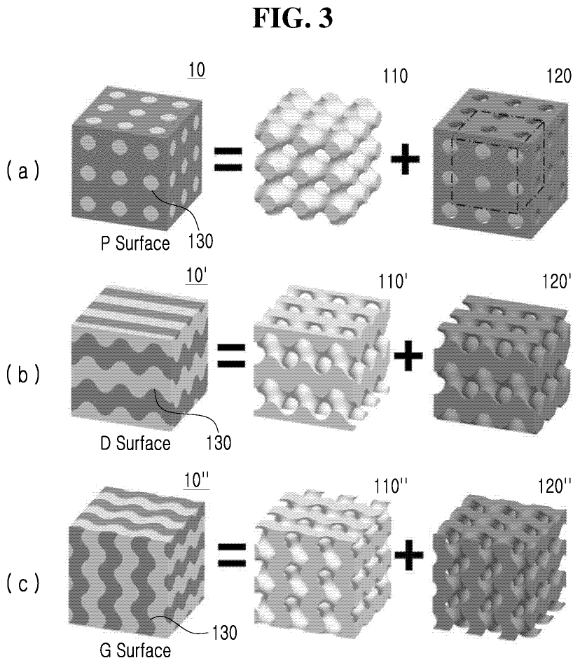

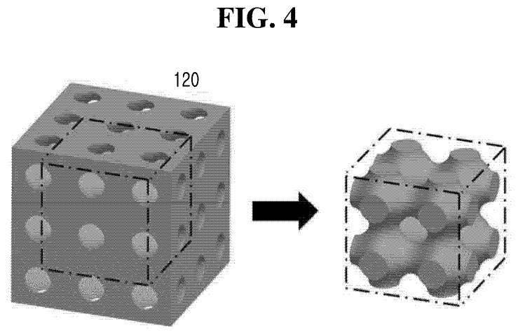

The present invention has a basic characteristic in that a shell structure in which an inner part is separated and partitioned into two sub volumes twisted by an interface and each sub volumes are continuous is configured as a main body of a pressure vessel so that a thickness of the shell is thin and a storage volume with respect to a weight is large while maintaining an excellent pressure resistance characteristic. Therefore, a mechanical basis for the operation and the effect will be described first, with reference to FIGS. 3 and 4, by comparing a pressure vessel 1 configured by a triply periodic minimal surface (TPMS) type shell structure 10, 10′, and 10″ according to a preferred exemplary embodiment of the present disclosure and a pressure vessel 1′ with a cylinder type shell as a representative example of the related art.

The interface 130 has a predetermined rigidity and thus it is expected that a movement of the material between first sub volumes 110, 110′, and 110″ and second sub volumes 120, 120′, and 120″ are suppressed. Further, in the present specification, ‘shell’ refers to a plane element which receives tension and compression only in a direction parallel to a plane from a mechanical point of view. Plane elements of the shell structures 10, 10′, and 10″ applied to the pressure vessel 1 are divided into ‘an intrinsic shell’ as a plane element related to a peculiar geometric structure of the cell structure and ‘an extrinsic shell’ which is separately added to be applied to the pressure vessel 1 to shield a space enclosed by the intrinsic shell from the outside as a plane element independent from the peculiar geometric structure of the cell structure.

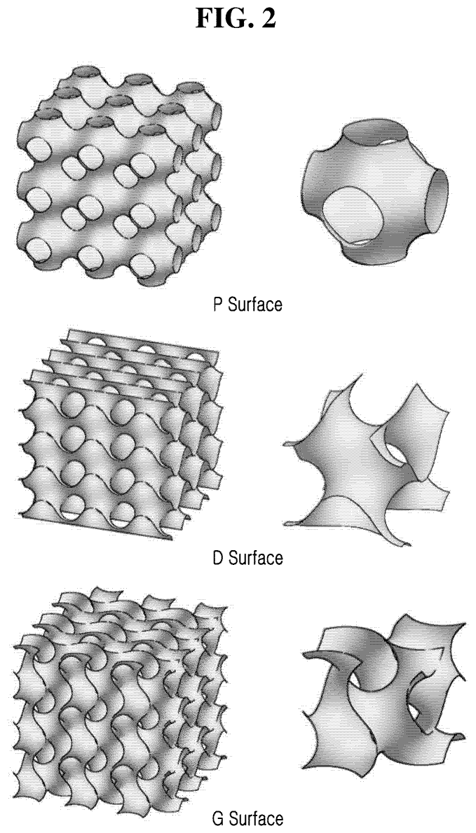

FIGS. 3A to 3C illustrate that the three-dimensional space is separated and partitioned into two sub volumes by a P, D, or G surface which is one of representative triply periodic minimal surfaces. In the meantime, in the case of a D surface of FIG. 3B and a G surface of FIG. 3C, two sub volumes which are separated into curved surfaces look similar, but in the P surface of FIG. 3A, two sub volumes look completely different. However, the difference of the P surface is just a phenomenon caused depending on a selected position of the outermost surface of the shell structures 10, 10′, and 10″. That is, in the P surface, when a unit cell is taken as illustrated in FIG. 2 and an outermost surface is taken at a border where the unit cell ends, a complete shape of the unit cell of the first sub volume 110, 110′, or 110″ which is any one of two sub volumes is exposed, but an intermediate part of the unit cell of the second sub volume 120, 120′, or 120″ which is the remaining sub volume is cut so that they look different. However, as illustrated in FIG. 4, when a position of the outermost surface is shifted by a half cycle, the second sub volume 120, 120′, or 120″ also looks similar to the first sub volume. Hereinafter, even though the mechanical basis of the pressure vessel 1 configured by the cell structure 10, 10′, or 10″ has been described with the P surface type shell structure 10 as an example, the description is also applied to the pressure vessel 1 with a different TPMS type of shell structure 10′ or 10″.

When it is assumed that an external appearance of the pressure vessel 1 has a hexahedral shape and a TPMS shell structure 10, 10′ or 10″ with a large number of unit cells is disposed in the hexahedron, according to the paper by Ban et al. (Ban Dang Nguyen, Yoon Chang Jeong, Kiju Kang, “Design of the P-Surfaced Shellular, an Ultra-Low Density Material with Micro-Architecture”, Computational Materials Science, Vol. 139, pp. 162-178, 2017), if an influence of an extrinsic shell which is in contact with the intrinsic shell at an outermost part of the hexahedron is ignored, the surface area of the shell in the unit cell is as represented by the following Equation 1.

$$\frac{A}{{D}_{s}^{2}} = - 13.054 {( f - 0.5 )}^{4} - 4.555 {( f - 0.5 )}^{2} + 2.34 \qquad [ Equation 1 ]$$

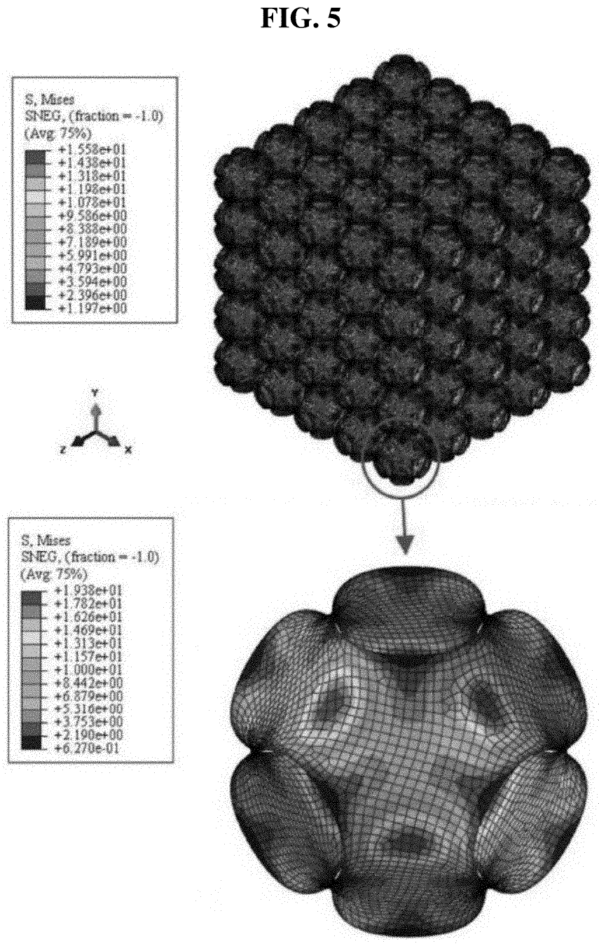

Here, A and Dₛ are a surface area in each unit cell and a size of a unit cell, respectively and f is a ratio of the first sub volume 110 with respect to an entire volume corresponding to a sum of the first sub volume 110 and the second sub volume 120 and is referred to as a volume fraction. The inventors of the present inventions performed a structural analysis on a situation where a pressure is applied to the inside of the first sub volume 110 of the P surface shell. FIG. 5 illustrates an example of a resulting Mises stress distribution. Through the structural analysis, a critical pressure P_{cr} at which yield occurs in the cell is represented by the following Equation 2.

$$\frac{{P}_{cr}}{{σ}_{o}} = 1.235 \times {f}^{- 0.8386} \times {( \frac{t}{{D}_{s}} )}^{1.001} \qquad [ Equation 2 ]$$

Here, σ₀ and t are a yield stress of the shell material and a thickness of the shell, respectively. In this case, the weight of the shell may be simply represented by the following Equation 3.

W=ρAt [Equation 3]

Here, ρ is a density of the shell material. Accordingly, when the critical pressure P_{cr} and a size Dₛ of the unit cell are given, a minimum weight at which the yield of the shell material does not occur may be represented by the following Equation 4 from the above-mentioned equations.

$$W = ρ At = ρ ( - 13.054 {( f - 0.5 )}^{4} - 4.555 {( f - 0.5 )}^{2} + 2.34 ) \times 0.8099 {{f}^{0.8378} ( \frac{{P}_{cr}}{{σ}_{o}} )}^{0.999} {D}_{s}^{3} \qquad [ Equation 4 ]$$

Consequently, according to an exemplary embodiment of the present invention, an external volume and an internal volume with respect to a weight in the pressure vessel 1 configured by a shell structure in which an inner portion is separated and partitioned into two sub volumes twisted with each other by the interface 130 and two sub volumes are continuous may be represented by the following Equations 5 and 6, respectively. In this case, the ‘external volume’ refers to a minimum hexahedral volume which encloses the unit cell and the ‘internal volume’ refers to a volume of a sub volume to which an internal pressure is applied. For reference, according to the present invention, since the pressure vessel 1 is configured by a three-dimensional cell structure 10, 10′, and 10″ with a plurality of unit cells, an equation for a mechanical basis which is developed with respect to the unit cell may be applied to the three-dimensional shell structures 10, 10′, and 10″ and the pressure vessel 1 including the same in the same manner.

$$\begin{matrix}\frac{V}{W} = \frac{{D}_{s}^{3}}{W} = \frac{1.2347}{ρ ( \begin{matrix}- 13.054 {( f - 0.5 )}^{4} - \\ 4.555 {( f - 0.5 )}^{2} + 2.34\end{matrix} ) {f}^{0.8378}} {( \frac{{σ}_{o}}{{P}_{cr}} )}^{0.999} & [ Equation 5 ] \\ \frac{{V}_{i n}}{W} = \frac{f \cdot {D}_{s}^{3}}{W} = \frac{1.2347 {f}^{0.1622}}{ρ ( \begin{matrix}- 13.054 {( f - 0.5 )}^{4} - \\ 4.555 {( f - 0.5 )}^{2} + 2.34\end{matrix} )} {( \frac{{σ}_{o}}{{P}_{cr}} )}^{0.999} & [ Equation 6 ]\end{matrix}$$

In contrast, in the case of the pressure vessel 1′ with a cylinder type shell of the related art, when an influence of a shield plate which blocks both ends of the cylinder is ignored, a surface area and a critical stress are represented by the following Equations 7 and 8, respectively.

$$\begin{matrix}A = π Dl & [ Equation 7 ] \\ \frac{{P}_{cr}}{{σ}_{o}} = \frac{2 t}{D} & [ Equation 8 ]\end{matrix}$$

Here, D and 1 are a diameter and a length of the cylinder, respectively. Accordingly, when the critical pressure P_{cr} and a size Dₛ of the unit cell are given, a minimum weight at which the yield of the shell material does not occur may be represented by the following Equation 9 from the above-Equations 7 and 8.

$$W = ρ At = ρ π Dlt = π ρ {D}^{2} l \frac{{P}_{cr}}{2 {σ}_{o}} \qquad [ Equation 9 ]$$

Consequently, in the pressure vessel 1 with a cylinder type shell of the related art, a volume of the entire external appearance and an internal volume with respect to the weight may be represented by the following Equations 10 and 11, respectively.

$$\begin{matrix}\frac{V}{W} = \frac{{D}^{2} l}{W} = \frac{2}{π ρ} \frac{{σ}_{o}}{{P}_{cr}} = \frac{0.6366}{ρ} \frac{{σ}_{o}}{{P}_{cr}} & [ Equation 10 ] \\ \frac{{V}_{i n}}{W} = \frac{π {D}^{2} l}{4 W} = \frac{1}{2 ρ} \frac{{σ}_{o}}{{P}_{cr}} = \frac{0.5}{ρ} \frac{{σ}_{o}}{{P}_{cr}} & [ Equation 11 ]\end{matrix}$$

The results are compared and summarized as represented in the following Table 1.

TABLE 1

| | Volume fraction, ƒ | $External volume with$ $respect to weight , \frac{V}{W}$ | $In ternal volume with$ $respect to weight , \frac{{V}_{in}}{W}$ |
|---|---|---|---|
| P-surface shell type pressure vessel | 0.3 | $\frac{1.5843}{ρ} {( \frac{{σ}_{o}}{{P}_{cr}} )}^{0.999}$ | $\frac{0.4753}{ρ} {( \frac{{σ}_{o}}{{P}_{cr}} )}^{0.999}$ |
| | 0.5 | $\frac{0.9431}{ρ} {( \frac{{σ}_{o}}{{P}_{cr}} )}^{0.999}$ | $\frac{0.4715}{ρ} {( \frac{{σ}_{o}}{{P}_{cr}} )}^{0.999}$ |
| | 0.7 | $\frac{0.7790}{ρ} {( \frac{{σ}_{o}}{{P}_{cr}} )}^{0.999}$ | $\frac{0.5453}{ρ} {( \frac{{σ}_{o}}{{P}_{cr}} )}^{0.999}$ |
| Cylinder type pressure vessel | $\frac{π}{4} = 0.785$ | $\frac{0.6366}{ρ} \frac{{σ}_{o}}{{P}_{cr}}$ | $\frac{0.5}{ρ} \frac{{σ}_{o}}{{P}_{cr}}$ |

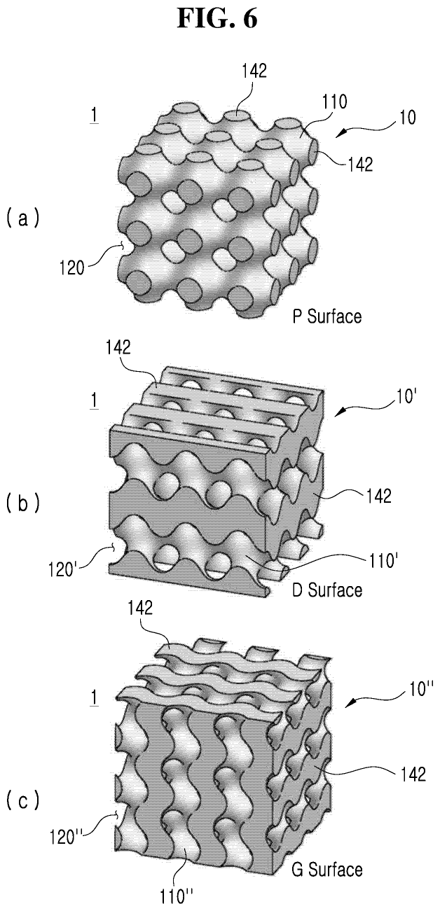

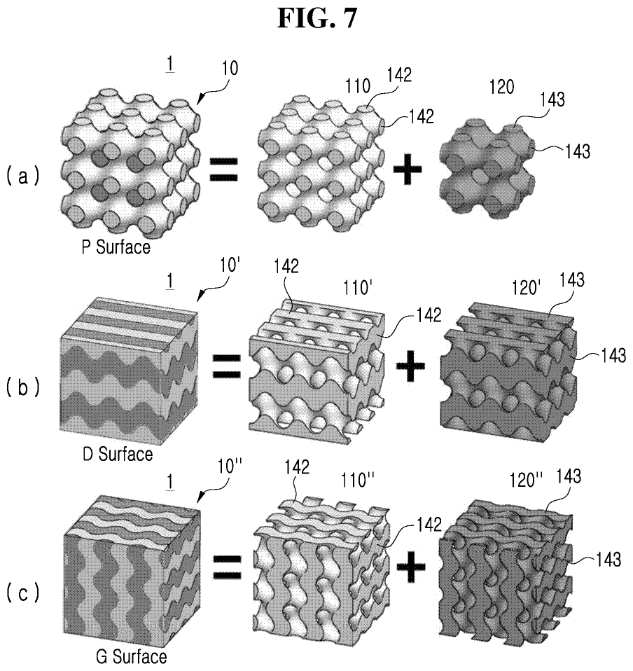

Here, it is assumed that shielding plates 142 and 143 (see FIGS. 6 and 7) of the P surface shell pressure vessel 1 as an extrinsic shell which shields an outer surface and shielding plates 142 and 143 as an extrinsic shell which shields both side surfaces of the cylinder type pressure vessel 1 have sufficiently higher strength than the intrinsic shells so that all damages occur in the intrinsic shells first. If the P surface shell type pressure vessel and the cylinder type pressure vessel 1 which endure the same highest pressure, that is, a critical pressure P_{cr} are fabricated with a material with the same density and the same yield strength, for example, when a volume fraction f of the P surface shell type pressure vessel 1 is 0.7, an external volume and an internal volume with respect to the weight may be slightly higher than those of the cylinder type pressure vessel 1. Specifically, it means that the P surface shell type pressure vessel 1 may be fabricated to have an amount of stored fluid with respect to the weight which is 9% higher than that of the cylinder type pressure vessel 1′ and an external volume which is 22% larger than that of the cylinder type pressure vessel 1′. However, even though the volume fraction f of the P surface shell type pressure vessel 1 is 0.7, there are two sub volumes in the P surface shell type pressure vessel 1. Therefore, if both the first sub volume 110 and the second sub volume 120 are used as storage spaces of the fluid, the P surface shell type pressure vessel 1 of the present invention may be configured to have a larger total amount of internal volume for storing the fluid and a smaller external volume than those of the cylinder type pressure vessel 1′ of the related art. In brief, when only any one of two sub volumes is utilized as a fluid storage space, in the pressure vessel 1 of the present disclosure, an amount of stored fluid may be reduced in accordance with the volume fraction f of the corresponding sub volume as compared with the related art. However, basically, the external volume with respect to the weight may be configured to be small and the other sub volume is also utilized as a fluid storage space to supplement and maximize the storage capacity. Further, the other sub volume may be utilized for a separate purpose for receiving or moving a heat exchange medium. In the meantime, according to the Equation 2, the critical pressure P_{cr} depends on a ratio t/Dₛ of a shell thickness with respect to a size of the unit cell, rather than a size of the entire external appearance so that if the shell thickness is configured to be small and the size of the unit cell is small at the same ratio, the critical pressure P_{cr} is not reduced in spite of the reduction of the shell thickness. This means that even though the interface 130 (see FIG. 3) of the shell is fabricated by plating or coating to make the thickness of the shell very thin, if the size of the unit cell is configured to be small in proportion to this, a desired sufficient pressure resistance characteristic may be imparted to the pressure vessel 1 as it will be described below. Further, the smaller the size of the unit cell, the more freely the external shape of the pressure vessel 1 may be implemented. The same description of the mechanical basis based on the P surface shell as described above may be also applied to another TPMS.

Exemplary Embodiment of Pressure Vessel and Fabricating Method Thereof

First, a structure of the pressure vessel 1 according to an exemplary embodiment of the present disclosure will be described with reference to FIGS. 6 to 11.

FIG. 6 is a view of a structure of a pressure vessel 1 configured by shell structures 10, 10′, and 10″ according to an exemplary embodiment of the present disclosure. The pressure vessel 1 includes a pressure resistant vessel or a vacuum vessel. An inner portion of the shell structures 10, 10′, and 10″ is separated and partitioned into two sub volumes formed of a first sub volume 110, 110′, or 110″ and a second sub volume 120, 120′, or 120″ twisted with each other by an interface 130 (see FIG. 3) and according to the exemplary embodiment, the interface 130 of the shell structure 10, 10′, or 10″ is implemented by a TPMS such as a P surface, a D surface, or a G surface as illustrated in FIGS. 6A to 6C, respectively. As mentioned above, the interface 130 has a predetermined rigidity and thus a movement of the material between the first sub volumes 110, 110′, and 110″ and the second sub volumes 120, 120′, and 120″ are suppressed. Further, the interface 130 has a curved profile and as mentioned above from a mechanical point of view, is considered as ‘a shell’ which receives tension and compression only in a direction parallel to a plane.

According to the present exemplary embodiment, it is exemplified that only any one of two sub volumes is provided as a fluid storage space and a shielding plate 142 is provided as an extrinsic shell which shields an outer surface of the corresponding sub volume. That is, a part of the sub volume provided as a storage space which is exposed to the outside is sealed by the shielding plate 142 excluding a part (not illustrated in the drawing) which carries the fluid in and out. In the present exemplary embodiment, the fluid storage space is exemplified by the first sub volume 110, 110′, or 110″ and the shielding plate 142 is exemplified to have a planar profile. Further, a part for carrying in/out the fluid may be perforated in an arbitrary position of the shielding plate 142 and may be a tubular member (not illustrated in the drawing) for an inlet or an outlet which is separately provided from the shielding plate 142. The inlet and the outlet may be arbitrarily provided in an appropriate position of the shell structure 10, 10′, and 10″. In the meantime, in the present invention, the pressure vessel 1 may be not only separately provided with an inlet and an outlet for carrying in/out the fluid for the practical purpose with a shielding plate 142, but also may be a shell structure 10, 10′, and 10″ itself provided with a shielding plate 142 excluding a part for carrying in/out the fluid.

Optionally, the remaining sub volume 120 which is not utilized as a fluid storage space may be provided as a space for receiving or moving the heat exchange medium depending on the purpose of the pressure vessel 1. For example, the heat exchange medium moves through the remaining sub volume to heat or cool through the heat exchange with the fluid in the storage space. In the present exemplary embodiment, the second sub volumes 120, 120′, and 120″ may be utilized as a space for receiving or moving the heat exchange medium. The heat exchange medium may be used for heating or cooling and the type thereof may be gas or liquid.

As long as a material has a predetermined rigidity suitable for the purpose of the pressure vessel 1, a material for the shell structure 10, 10′, or 10″ is not specifically limited. For example, the interface 130 which configures the shell structure 10, 10′, or 10″ may be formed of a high-strength metal or a resin material. Further, the material of the shielding plate 142 as an extrinsic shell for shielding the outer surface of the sub volume 110, 110′, or 110″ to be utilized as a fluid storage space is not specifically limited if the material has a predetermined rigidity, similarly to the interface 130, and may be configured by the same material or a different material from the interface 130. However, according to the present exemplary embodiment, when the shielding plate 142 has a planar shape and the shielding plate 142 is formed of the same material as the interface 130, the thickness of the shielding plate needs to be larger than the thickness of the interface 130 so as not to yield earlier than the interface 130 due to the applied pressure. As it will be described below, as a plane element of the shell structure 10, 10′, or 10″ for the pressure vessel 1, the interface 130 and the shielding plate 142 are formed by coating based on a template 20 or formed by mutual combining a plurality of divided processing elements.

When the shell structure 10, 10′, or 10″ is configured by configuring the interface 130 with the TPMS, all the rigidity of the shell structure 10, 10′, or 10″ itself and a pressure resistance characteristic in the sub volume 110, 110′, or 110″ utilized as a fluid storage space, and a fluid permeability in the sub volume which is utilized as a storing and moving passage of the heat exchange medium may be remarkably improved as compared with not only the sphere type or cylinder type pressure vessel 1′ of the related art, but also the pressure vessel 1 formed of a shell structure 10, 10′, or 10″ simply configured by two sub volumes.

FIG. 7 is a view of a structure of a pressure vessel 1 configured by shell structures 10, 10′, and 10″ according to another exemplary embodiment of the present disclosure. Similarly to FIG. 6, the interface 130 of the shell structure 10, 10′, or 10″ according to the present exemplary embodiment is implemented by a TPMS such as a P surface, a D surface, and a G surface as illustrated in FIGS. 7A to 7C. Unlike the exemplary embodiment of FIG. 6, the pressure vessel 1 according to the present exemplary embodiment is an example that both two sub volumes are provided as a fluid storage space to maximize a storage space and for the convenience of understanding, a state in which the sub volumes are separately recognized is illustrated in the drawing. In the present exemplary embodiment, the first sub volume 110, 110′, or 110″ and the second sub volume 120, 120′, or 120″ provided as a fluid storage space are provided with separate shielding plates 142 and 143 as extrinsic shells for shielding the outer surfaces. However, even though the first sub volume 110, 110′, or 110″ and the second sub volume 120, 120′, or 120″ are separately recognized to be illustrated in the drawing, the first sub volume 110, 110′, or 110″ and the second sub volume 120, 120′, or 120″ share the interface 130, but are not formed by separate shells so that when an actual pressure vessel 1 is fabricated, only the shielding plates 142 and 143 are added as extrinsic shells. In the exemplary embodiment, the matters concerning the material of the interface 130 and the shielding plates 142 and 143, a thickness design based on the shape or the material of the shielding plates 142 and 143, and formation of an inlet and an outlet for carrying in/out the fluid are the same as the exemplary embodiment of FIG. 6.

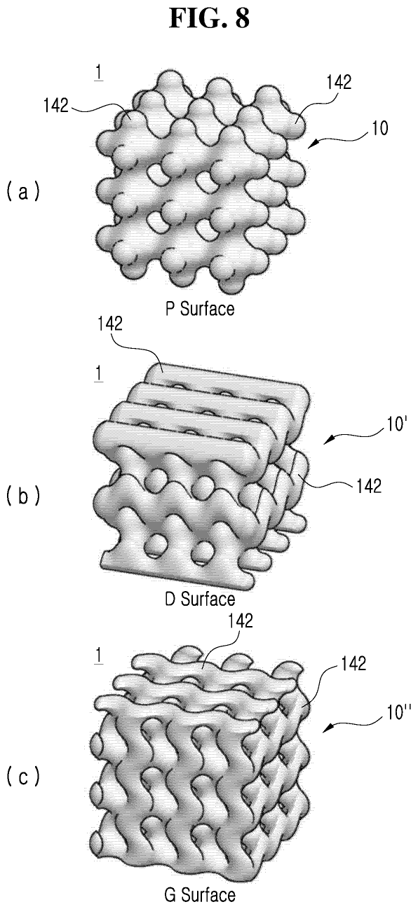

FIG. 8 is a view of a structure of a pressure vessel 1 configured by shell structures 10, 10′, and 10″ according to still another exemplary embodiment of the present disclosure. Similarly to FIGS. 6 and 7, the interface 130 of the shell structure 10, 10′, or 10″ according to the present exemplary embodiment is also implemented by a TPMS such as a P surface, a D surface, and a G surface as illustrated in FIGS. 8A to 8C. One of two sub volumes of the pressure vessel 1 according to the exemplary embodiment is provided as a fluid storage space, similarly to FIG. 6, but the shielding plate 142 has a curved profile which protrudes outwardly from the storage space, differently from FIG. 6. In the present exemplary embodiment, the shielding plate 142 has a convex curved profile so that when a pressure is increased in the storage space, a pressure applied to the shielding plate 142 may be alleviated and thus it is advantageous in that the thickness of the shielding plate 142 may be formed to be small. The convex curved profile may be designed to have an expanded shape in accordance with the increase of the internal pressure by assuming that the shielding plate 142 is configured with an elastic material.

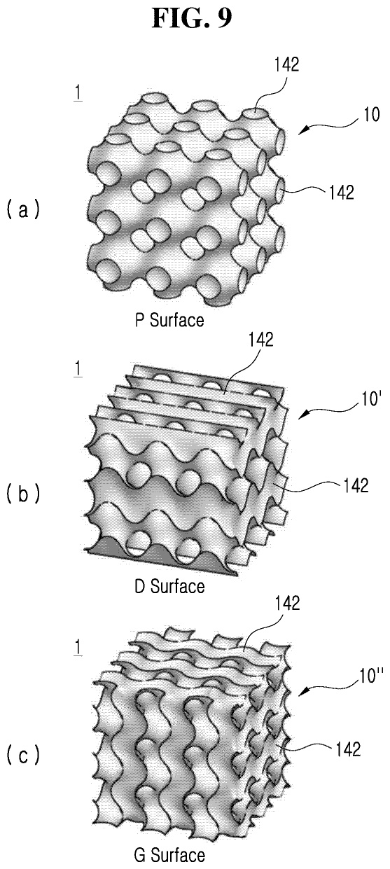

FIG. 9 is a view of a structure of a pressure vessel 1 configured by shell structures 10, 10′, and 10″ according to still another exemplary embodiment of the present disclosure. Similarly to FIG. 8, the interface 130 of the shell structure 10, 10′, or 10″ according to the present exemplary embodiment is implemented by a TPMS such as a P surface, a D surface, and a G surface as illustrated in FIGS. 9A to 9C. One of two sub volumes of the pressure vessel 1 according to the exemplary embodiment is provided as a fluid storage space, similarly to FIG. 8, but the shielding plate 142 has a curved profile which is concave inwardly from the storage space, differently from FIG. 8. In the present exemplary embodiment, the shielding plate 142 has a concave curved profile so that similarly to FIG. 8, when a pressure is decreased in the storage space, a pressure applied to the shielding plate 142 is alleviated. Therefore, it is advantageous in that the thickness of the shielding plate 142 may be formed to be small and an external volume such as a hexahedral shape which encloses the pressure vessel may be minimized. The concave curved profile may be designed to have a contracted shape in accordance with the decrease of the internal pressure by assuming that the shielding plate 142 is configured with an elastic material.

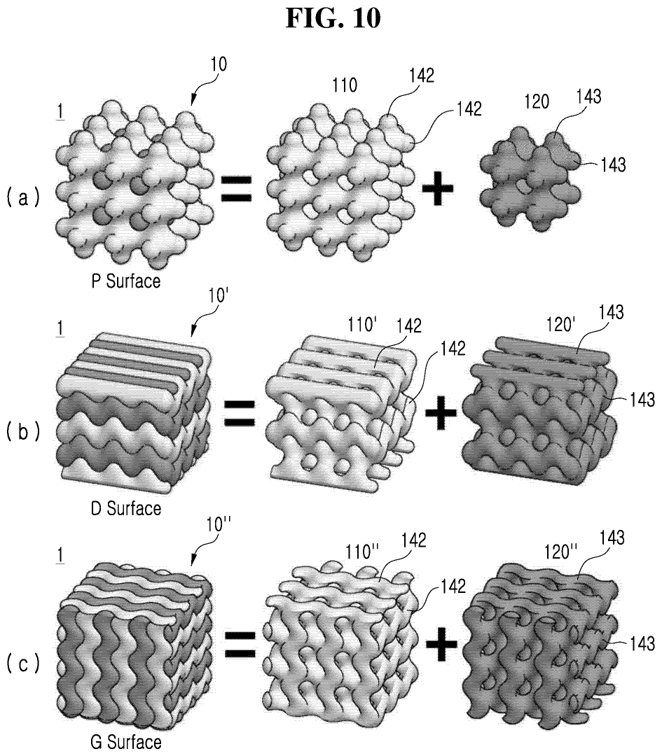

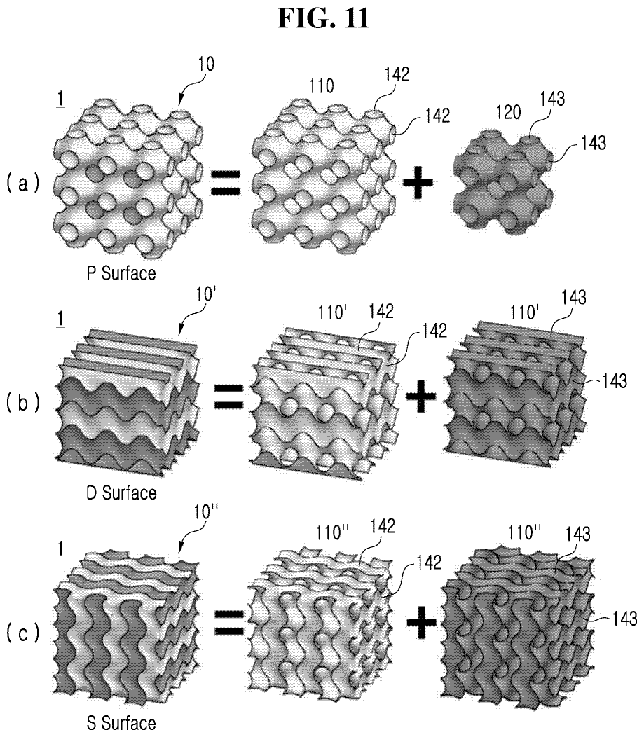

In the meantime, the remaining sub volume which is not utilized as the fluid storage space in the exemplary embodiments of FIGS. 8 and 9 may be provided as a space for storing or moving a heat exchange medium, similarly to FIG. 6. Further, the exemplary embodiments of FIGS. 8 and 9 are modified such that as illustrated in FIG. 7, the remaining sub volume may also be utilized as a fluid storage space, which will be illustrated in FIGS. 10 and 11. In FIGS. 10 and 11, for the convenience of understanding, the state in which the sub volumes are separately recognized is separately illustrated in the drawings, as illustrated in FIG. 7. In this case, similarly to FIG. 7, even though the first sub volume 110, 110′, or 110″ and the second sub volume 120, 120′, or 120″ are separately recognized to be illustrated in the drawing, the first sub volume 110, 110′, or 110″ and the second sub volume 120, 120′, or 120″ share the interface 130, but are not formed by separate shells so that when an actual pressure vessel 1 is fabricated, only the shielding plates 142 and 143 are added as extrinsic shells. In the exemplary embodiments of FIGS. 10 and 11, both two sub volumes which are separated by the TPMS type interface 130 are utilized as the fluid storage space, which is the same as the exemplary embodiment of FIG. 7. However, in FIG. 10, the shielding plates 142 and 143 provided in each sub volume have a convex curved profile which protrudes outwardly from the storage space and in FIG. 11, the shielding plates have a concave curved profile which is concave inwardly from the storage space, which are different from the exemplary embodiment of FIG. 7. In the exemplary embodiments of FIGS. 10 and 11, a desirable shape of the curved profile of the shielding plates 142 and 143 and an advantage thereof are the same as described with reference to FIGS. 8 and 9.

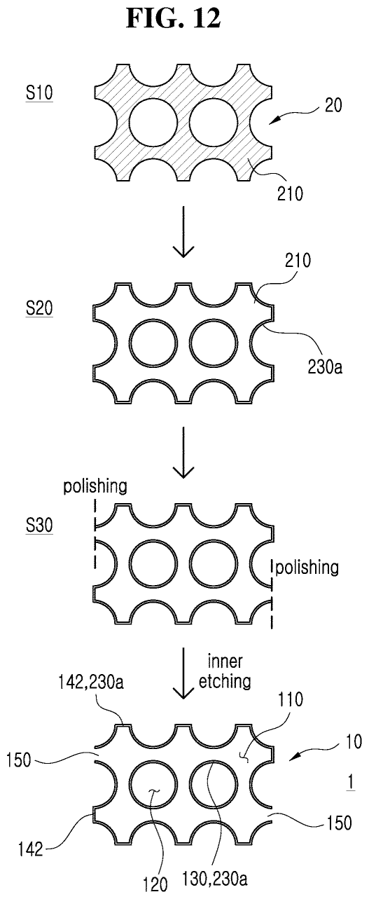

Next, a fabricating method of the pressure vessel 1 according to an exemplary embodiment of the present disclosure will be described with reference to FIGS. 12 to 15.

FIG. 12 illustrates a view of a fabricating process of a pressure vessel 1 according to an exemplary embodiment of the present disclosure and is applied when the pressure vessel 1 in which any one of two sub volumes of a TPMS shell structure 10, 10′, or 10″ according to the exemplary embodiments of FIGS. 6, 8, and 9 is provided as a fluid storage space is fabricated. In the drawings, for the convenience of description, a P surface is exemplified as the TPMS and a template 20 serving as a mold of a three-dimensional shell structure 10 is two-dimensionally illustrated.

Referring to FIG. 12, the fabricating method of the pressure vessel 1 is performed by including a step S10 of fabricating a template 20 in which a sub volume provided as a fluid storage space is filled with a template material 210, a step S20 of forming a first coating film 230a on an entire surface of the template 20, and a step S30 of exposing and then removing the template 20 by removing a part of the first coating film 230a.

An entire major process of the pressure vessel 1 which is configured by the three-dimensional shell structure 10 may be fabricated by applying a fabricating method based on photo lithography disclosed through a preceding paper by the inventors (S. C. Han, J. W. Lee, K. Kang. A new type of low-density material; Shellular. Advanced Materials, Vol. 27, pp. 5506-5511, 2015). Further, among the following fabricating processes, the TPMS template 20 may be fabricated according to Korean Registered Patent Nos. 1341216 and 1699943 and Korean Unexamined Patent Application Publication No. 10-2018-0029454 by the inventors. Accordingly, the contents described in the papers and the earlier patent applications may be incorporated by reference as a part of the present invention.

Specifically, in step S10, the template 20 may use a resin (Thiolen) structure cured with ultraviolet rays irradiated through a mask, a flexible wire woven structure impregnated with a resin, or a polymer bead assembly which is regularly arranged and then partially etched and thus as the material for the template 210, a resin, metal, or a composite material thereof may be used.

In step S20, the first coating film 230a is applied on the entire surface of the template 20, that is, on both an inner surface and an outer surface of the shell structure 10. The first coating film 230a configures the interface 130 and the outer peripheral surface of the shell structure 10 so that a high strength metal, ceramic or resin material may be used. A forming method of the first coating film 230a may be selected depending on the material. For example, electrolytic plating, electroless plating, atomic film deposition, chemical vapor deposition, etc. may be used for the metal. Atomic film deposition, chemical vapor deposition, or physical vapor deposition may be used for the ceramic and dip coating or chemical vapor deposition may be formed for the resin.

In step S30, the first coating film 230a may be removed by a polishing method. The removal of the first coating film 230a is performed on a part of the template 20 which protrudes so that a template material 210 below the first coating film 230a is exposed. The template material 210 is etched using an etchant which permeates through an area where the first coating film 230a to be discharged and removed.

By doing this, the pressure vessel 1 configured by the three-dimensional shell structure 10 having a first sub volume 110 and a second sub volume 120 which are twisted with each other by the interface 130 therein may be fabricated, as described in the exemplary embodiment, only the first sub volume 110 between two sub volumes is provided as a fluid storage space. In this case, the first coating film 230a forms the interface 130 and the outer peripheral surface of the shell structure 10 and the outer peripheral surface includes the shielding plate 142 surface as an extrinsic shell which shields an outer surface of the first sub volume 110 corresponding to the fluid storage space. The area where the first coating film 230a is removed may serve as an inlet/outlet 150 for carrying in/out the fluid in the pressure vessel 1 which is a final result. In the meantime, in the exemplary embodiment, the shielding plate 142 surface for the fluid storage space is expected to be a planar profile as illustrated in FIG. 6 and the corresponding template 20 surface is illustrated to have a planar profile. However, when the shielding plate 142 surface with a curved profile is formed as illustrated in FIGS. 8 and 9, the template 20 surface may be processed in advance on the shielding plate 142 surface to correspond to the curved profile (not illustrated in the drawing) prior to the step S20.

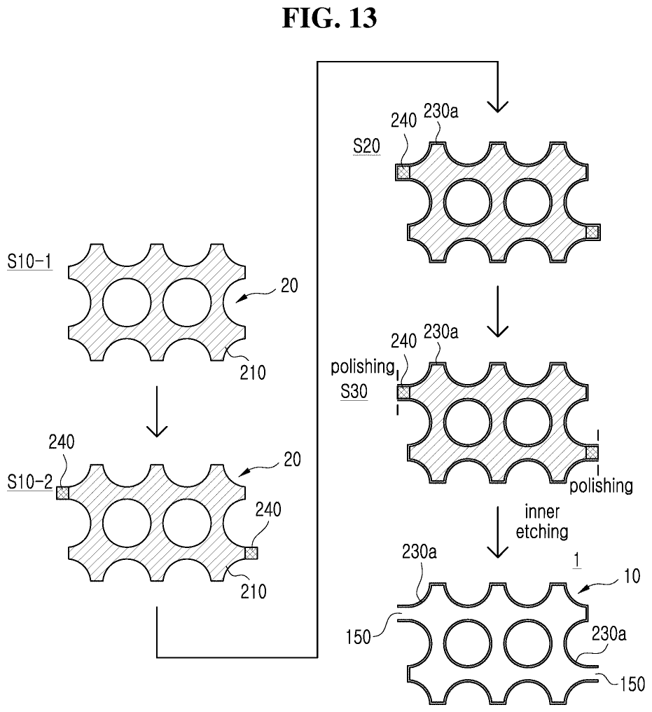

FIG. 13 is a fabricating process view of a pressure vessel 1 according to a modified embodiment of FIG. 12. In the exemplary embodiment of FIG. 13, the inlet/outlet 150 which communicates with the fluid storage space is implemented with a tubular member to be integrated with the shell structure 10. Specifically, the step S10 of FIG. 12 further includes a step S10-2 of connecting a sealing material for forming the inlet/outlet 150 to the exposed template material 210 after fabricating the template 20 (S10-1). In step S20 of FIG. 12, the first coating film 230a is formed on the template material and the entire exposed surface of the sealing material 240 for forming the inlet/outlet 150, in step S30 of FIG. 12, after exposing the sealing material 240 by removing a part of the first coating film 230a, the sealing material 240 and the template material 210 are sequentially removed and the area where the sealing material 240 is removed is formed as the inlet/outlet 150 for carrying in/out the fluid. In FIG. 13, a process of connecting the sealing material 240 may be formed as a part of the fabricating process of the template 20 before forming the coating film, so that the overall process is not much different from FIG. 12.

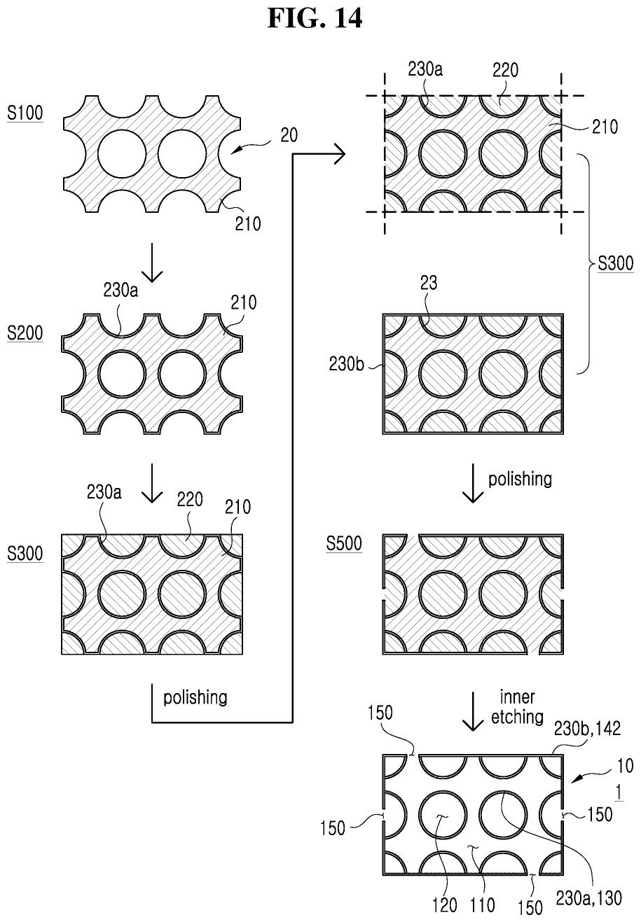

FIG. 14 is a fabricating process view of a pressure vessel 1 according to another exemplary embodiment of the present invention. It is applied when a pressure vessel 1 according to the exemplary embodiments of FIGS. 7, 10, and 11 in which both two sub volumes of the TPMS shell structure 10 are provided as a fluid storage process. Similarly to FIG. 12, in FIG. 14, for the convenience of description, the P surface is exemplified as the TPMS and a template 20 serving as a mold of a three-dimensional shell structure 10 is two-dimensionally illustrated.

Referring to FIG. 14, the fabricating method of the pressure vessel 1 is performed by including a step of fabricating a template 20 in which any one of the first sub volume 110 and the second sub volume 120 is filled with a first template material 210, a step S200 of forming the first coating film 230a on the entire surface of the template 20, a step S300 of filling an empty space of the other one of the first sub volume 110 and the second sub volume 120 with the second template material 220, a step S400 of forming a second coating film 230b after polishing the entire outer peripheral surface of the template 20 to expose a cross-section of the first coating film 230a, and s step S500 of exposing and then removing the first template material 210 and the second template material 220 by removing a part of the second coating material 230b. In this case, the first template material 210 and the second template material 220 may be the same or different, but the same material is used for the first template material 210 and the second template material 220 to simplify the etching process. Further, even though the first coating film 230a and the second coating film 230b may use the same or different material, the same material is used to improve the adhesive quality between the first coating film 230a and the second coating film 230b.

Therefore, the pressure vessel 1 configured by the three-dimensional shell structure 10 having a first sub volume 110 and a second sub volume 120 which are twisted with each other by the interface 130 therein may be fabricated, as described in the exemplary embodiment, both the first sub volume 110 and the second sub volume 120 are provided as a fluid storage space. In this case, in the step S400, an end of the first coating film 230a may be in contact with the surface of the second coating film 230b to be coupled. Consequently, the first coating film 230a forms the interface 130 of the shell structure 10 and the second coating film 230b forms an outer peripheral surface of the shell structure 10. The outer peripheral surface of the shell structure 10 may include shielding plates 142 and 143 surfaces as extrinsic shells for shielding the outer surfaces of the first sub volume 110 and the second sub volume 120 corresponding to the fluid storage space. The area where the second coating film 230b is removed may serve as an inlet/outlet 150 for carrying in/out the fluid in the pressure vessel 1 which is a final result. In the meantime, in the exemplary embodiment, the shielding plates 142 and 143 surfaces for the fluid storage space are expected to be a planar profile as illustrated in FIG. 7 and the corresponding template 20 surface is illustrated to have a planar profile. However, when the shielding plate 142 and 143 surfaces with a curved profile are formed as illustrated in FIGS. 10 and 11, the template 20 surface may be processed in advance on the shielding plate 142 and 143 surfaces to correspond to the curved profile (not illustrated in the drawing) prior to the step S20.

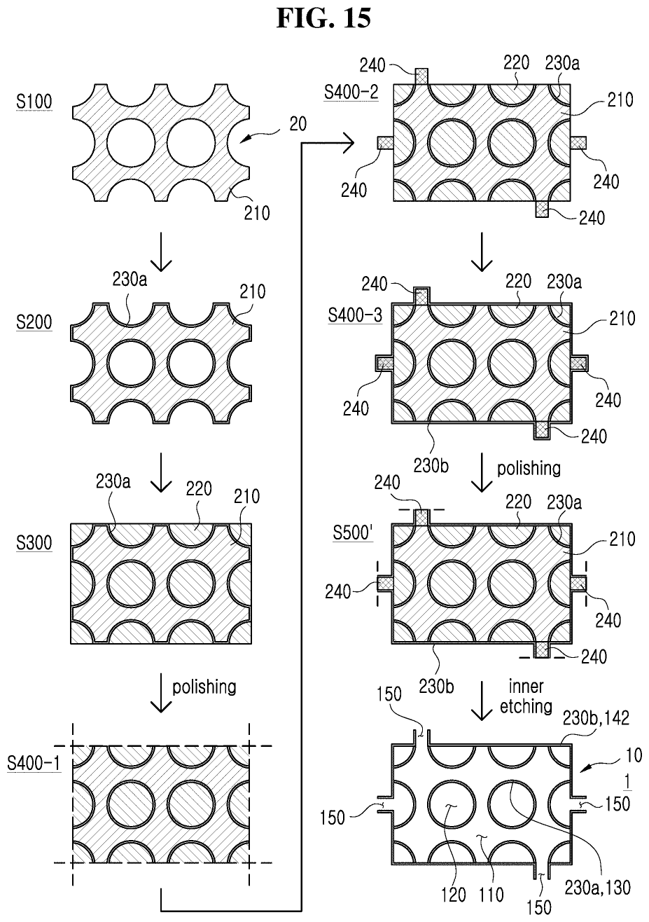

FIG. 15 is a fabricating process view of a pressure vessel 1 according to a modified embodiment of FIG. 14. In the exemplary embodiment of FIG. 14, the inlet/outlet 150 which communicates with the fluid storage space is implemented with a tubular member to be integrated with the shell structure 10. To this end, instead of the step S400 of FIG. 14, a step S400-1 of polishing the entire outer peripheral surface of the template 20 to expose the cross-section of the first coating film 230a, the first template material 210, and the second template material 220, a step S400-2 of connecting a sealing material 240 for forming the inlet/outlet 150 to the first template material 210 and the second template material 220 which are exposed, and a step S400-3 of forming the second coating film 230b on the sealing material 240 and the exposed outer peripheral surface of the template 20 are included. Further, instead of the step S500 of FIG. 14, after exposing the sealing material 240 by removing a part of the second coating film 230b, the sealing material 240, the first template material 210, and the second template material 220 are sequentially removed (S500′). In this case, similarly to FIG. 13, as long as the sealing material 240 may be removed by etching, it is not specifically limited, and the same material as the template material 210 is used to advantageously simplify the etching process. Therefore, in the final pressure vessel 1 configured by the shell structure 10, the second coating film 230b is integrally formed with the first coating film 230b and forms an inlet/outlet 150 in the form of a tubular member.

The exemplary embodiments illustrated in FIGS. 12 to 15 are useful for fabricating a pressure vessel 1 configured by a large number of unit cells which are usually several millimeters or less in size. According to the above Equations 2 and 8, the critical stress P_{cr} of the pressure vessel 1 according to the present invention is proportional to a shell thickness with respect to the size of the unit cell, t/Dₛ and the critical stress of the pressure vessel 1 of the related art is proportional to a shell thickness with respect to a diameter of the vessel, t/D. Therefore, when the pressure vessel 1 according to the present invention is formed by a large number of unit cells with a small size, even though the thickness t of the shell is small, the pressure vessel may be fabricated to have the same critical pressure as the pressure vessel of the related art with a large diameter. For example, under the premise that the material which configures the pressure vessel 1 is the same, when the pressure vessel 1 according to the present invention has a P surface, a volume fraction f is 0.5, and a size of the unit cell Dₛ is 10 mm, if the thickness t of the shell is 0.1 mm (t/Dₛ is 0.01), the same critical pressure as the cylinder type pressure vessel of the related art with a diameter of 1 m and a thickness of a shell of 10 mm (t/D is 0.01) may be obtained. Accordingly, the TPMS type pressure vessel 1 fabricated by being coated on the template 20 and then etched according to the present invention may have the same pressure resistance strength as the pressure vessel 1 of the related art.

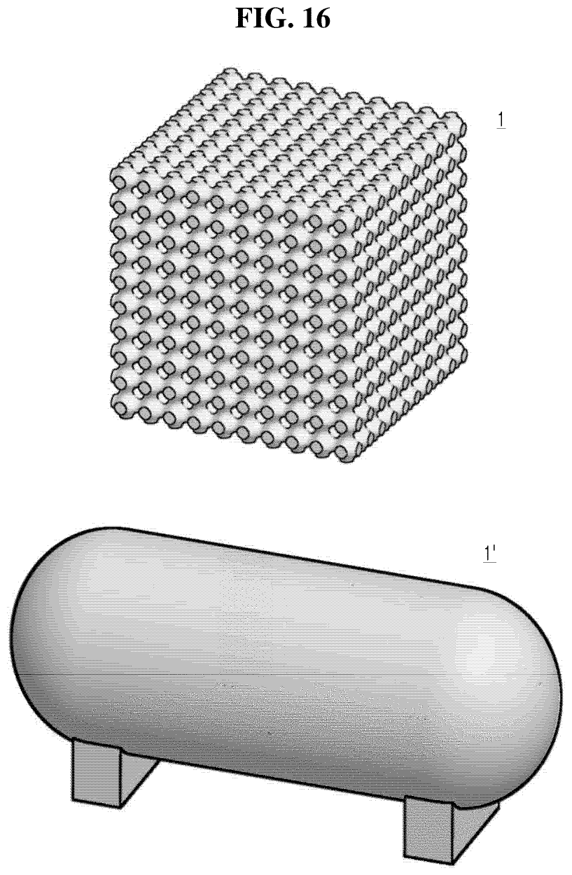

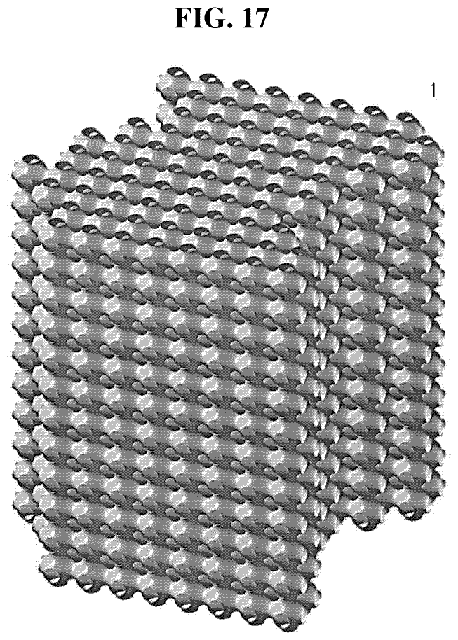

Referring to FIG. 16, when the cylinder type pressure vessel 1′ of the related art and the P surface pressure vessel 1 according to the present invention have a similar external volume, but a diameter of the pressure vessel of the related art is 10 times the cell size of the P surface pressure vessel, the shapes of the pressure vessels 1 are compared. If the volume fraction f is 0.5 and two sub volumes are used as a fluid storage space as illustrated in FIGS. 7, 10, and 11, as described according to the mechanical basis, the pressure vessel 1 according to the present invention may be implemented to have the higher internal volume and critical pressure with respect to the weight than the cylinder type pressure vessel 1 of the related art while making the cell thickness 1/10. Further, by changing the arrangement method of the cells, the external appearance of the pressure vessel 1 is freely formed and the example thereof is illustrated in FIG. 17.

In the meantime, in the pressure vessel designed to be applied with a high pressure, if cracks generated in the shell are unstably broken, tragic disaster is caused. In order to prevent this problem, a design concept of ‘leak before break or leak before burst’ which induces leakage of the high pressure internal fluid by passing through the sell before the cracks become unstable is applied to the pressure vessel (written by N. E. Dowling, Mechanical Behavior of Materials, 3^{rd} Edition, Pearson Prentice Hall, 2007, p. 347.) (Applicability of the leak before break concept, IAEA Technical Report, IAEA-TECDOC-710, 1993). Accordingly, when the thickness of the shell in the pressure vessel which stores the high-pressure fluid is formed to be small as much as possible, the ‘leak before break’ is induced to ensure the safety. As described above, as in the pressure vessel 1 according to the present invention, when the pressure vessel is configured by a plurality of unit cells with a small size, even though the shell thickness is small, the same pressure resistance strength as the pressure vessel 1 of the related art configured by the thick shell is ensured so that ‘leak before break’ may be guaranteed.

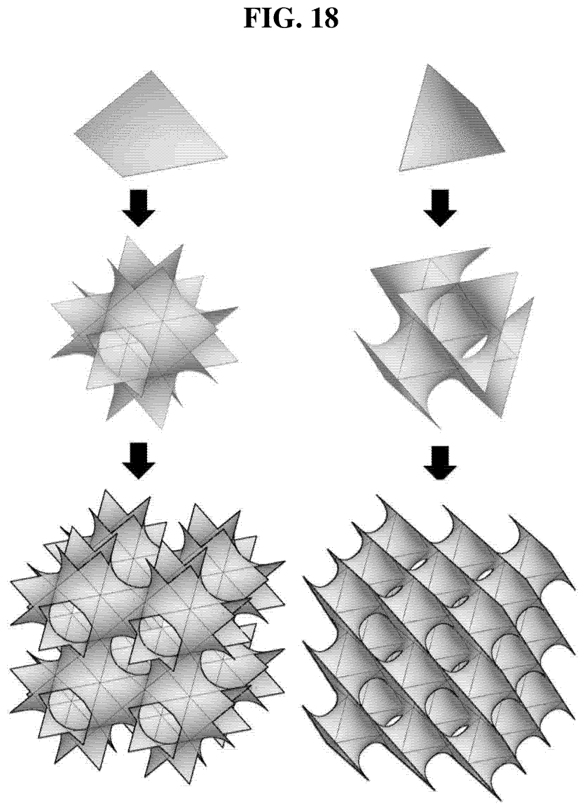

In the meantime, when the size of the unit cell of the pressure vessel 1 according to the present invention is as large as several tens of cm to several m, instead of the fabricating method of FIGS. 12 to 15, similar to the fabricating method of the pressure vessel 1 of the related art, the plane element corresponding to the interface 130 and the outer peripheral surface of the shell structures 10, 10′, or 10″ is divided into a plurality of parts to be coupled. As the coupling method, when the plane element is metal such as a steel material, a welding method may be used. This is based on a fact that the triple periodic minimal surface (TPMS) is configured by combining rectangular unit curved surfaces with a constant average curvature. FIG. 18 illustrates that the unit cells of the P surface and the D surface are configured by rectangular unit curved surfaces with a constant average curvature. That is, a plurality of unit cells which is formed in advance to have a constant average curvature is coupled to each other to fabricate an intrinsic shell structure 10, 10′, or 10″ of the pressure vessel 1.

The above description relates to specific exemplary embodiments of the present invention. The above-described exemplary embodiment according to the present invention is not understood to limit the matters disclosed for the purpose of explanation or the scope of the present invention, but it is understood that those skilled in the art can make various modifications or changes without departing from the gist of the present invention. Therefore, it can be understood that all changes and modifications correspond to the scope of the invention disclosed in the claims or an equivalent thereof.

1. A three-dimensional shell structure for a pressure vessel in which an inner part is separated and partitioned into two sub volumes configured by a first sub volume and a second sub volume which are twisted with each other by an interface, wherein at least one of the two sub volumes is provided as a storage space for receiving a fluid and a part of the sub volume provided as the storage space which is exposed to the outside, excluding a part for carrying in/out the fluid, is sealed by a shielding plate.

2. The three-dimensional shell structure for a pressure vessel of claim 1, wherein the interface is a triply periodic minimal surface (TPMS).

3. The three-dimensional shell structure for a pressure vessel of claim 1, wherein a sub volume other than the storage space is provided as a space for receiving or moving a heat exchange medium.

4. The three-dimensional shell structure for a pressure vessel of claim 1, wherein the shielding plate has a planar or curved profile.

5. The three-dimensional shell structure for a pressure vessel of claim 4, wherein the shielding plate is convex outwardly from the storage space or is concave inwardly from the storage space.

6. A pressure vessel comprising:
a three-dimensional shell structure of claim 1; and
an inlet/outlet which communicates with the storage space to provide a passage for carrying in/out a fluid.

7. A fabricating method of a pressure vessel with a shell structure in which an inner part is separated and partitioned into two sub volumes configured by a first sub volume and a second sub volume twisted with each other by an interface therein and any one of the first sub volume and the second sub volume is provided as a storage space for receiving a fluid, the method comprising:
(A) fabricating a template in which any one of the first sub volume and the second sub volume is filled with a template material;
(B) forming a first coating film on an entire surface of the template; and
(C) exposing and then removing the template material by removing a part of the first coating film,
wherein the first coating film forms the interface and an outer peripheral surface of the shell structure.

8. The fabricating method of a pressure vessel of claim 7, wherein
the step (A) further includes connecting a sealing material for forming an inlet/outlet to the exposed template material, in the step (B), a first coating film is formed on the entire exposed surface of the template material and the sealing material for forming an inlet/outlet, and
in the step (C), a part of the first coating film is removed to expose the sealing material and then the sealing material and the template material are sequentially removed so that an area where the sealing material is removed is formed as an inlet and an outlet for carrying in/out a fluid.

9. (canceled)

10. (canceled)

11. A fabricating method of a pressure vessel with a shell structure in which an inner part is separated and partitioned into two sub volumes configured by a first sub volume and a second sub volume twisted with each other by an interface therein and at least one of the first sub volume and the second sub volume is provided as a storage space for receiving a fluid, wherein a plane element corresponding to the interface and the outer peripheral surface of the shell structure is divided into a plurality of parts to be coupled to each other.
